(19) United States
(12) Patent Application Publication
(10) Pub. No.: US 2004/0114047 A1
(43) Pub. Date: Jun. 17, 2004

(54) Method for transforming an offset sensor array

(76) Inventors: Poorvi L. Vora, Corvallis, OR (US); Russell M. Iimura, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 10/318,482

(22) Filed: Dec. 13, 2002

(51) Int. Cl. H04N 5/225

(52) U.S. Cl. 348/340

(57) ABSTRACT

A method is provided for demosaicing an offset geometric array. The method comprises the step of arranging a plurality of sensors in an offset geometric array. The sensors have a defined geometric shape for each sensor and its respective sensor sample. Another step is moving first sample from the sensor in an odd row of the offset geometric array to an uppermost point of a geometric shape. A further step is moving second sample from the sensor in an even row of the offset geometric array to a point that is vertically aligned with the first sample from the odd row. The point is also contained within the same geometric shape as the first sample from the odd row.

### FIELD OF THE INVENTION

The present invention relates generally to transforming offset sensor array samples.

### BACKGROUND

Single-sensor imaging systems generally consist of a monochrome image sensor array for sampling incoming light. Sensing units in this type of array are frequently charge-coupled device (CCD) arrays or CMOS arrays, and the individual sensing units or circuits represent image pixels. This type of arrangement is often used in digital cameras, camcorders, copiers, scanners, and similar imaging systems.

Each physical sensor unit is covered by a color filter and the sensor measures the amount of light received for the color passed through the filter. This means that for any given sensor in the array, just one color will be measured. In other words, the sensors are by nature monochromatic.

In order to capture color images, these elements must be grouped into several types, typically red, green and blue. To make the red elements sense red light, red filter material (green and blue absorbing) is placed over the element. The same is done for the green and blue elements. These color element groupings are sometimes known as frames (e.g., a red frame, blue frame, etc.). These several types of elements are arranged in some pattern, usually regular and rectangular, to make up the sensor array.

The pattern in which the color filters are laid on the sensor array is referred to as a mosaic pattern. There can be any number of types of color filters, and in general the color filters can be of any color. The most common choice is a set of red, green, and blue (RGB) filters laid in the Bayer pattern as shown below.

RGRGRGRGRG
GBGBGBGBGB

Because a measurement for just one color is obtained at each pixel or sampling position, the raw image collected from the array is a mosaic of red, green and blue pixels. In order to reconstruct the original full-color image, the sensor measurements need to be demosaiced to obtain three RGB values at each pixel (i.e., sensor). Demosaicing is the process of interpolating pixels in order to fill in the missing values. For instance, the pixel which corresponds to a green CCD element will need to infer from neighboring elements what the red and blue values are at that point. Such an interpolation can be carried out by applying a weighting matrix or kernel to the neighborhood around a missing value. The size of the neighborhood and the shape of the kernel (i.e., the values of the weights) are generally selected to optimize a certain set of images and colors that are considered representative of the scenes to be photographed. Some demosaicing methods choose these parameters just after the image is captured by the sensors, to optimize these for the particular scene itself.

If the color filters are not RGB filters, (for example, they can be cyan, magenta, yellow, green CMYG), the individual measurements can be numerically manipulated to get estimates of the RGB values. Once the RGB values are calculated for each pixel, they can then be color corrected, balanced, or normalized to obtain standardized RGB values. The corrected values may not be identical to the measured RGB values at the illuminant under which the image is to be viewed. Furthermore, the measured RGB may not be identical to the real world illuminant in which the scene was recorded. After the demosaiced image is created then the image is often compressed to speed-up the image output and to minimize storage space on the camera as well as on other devices the image might be transferred to, such as a personal computer.

Unfortunately, the process of interpolation can be computationally expensive. Interpolating millions of pixels is a relatively slow process and combining this with image compression can produce a noticeable bottleneck in image output or processing. A demosaicing algorithm is only one intermediate step along the whole image acquisition pipeline. However, the demosaicing step also affects the data that is available for later processing. If the demosaicing algorithm irretrievably alters the data, then the later processing of the data will also be affected.

### SUMMARY OF THE INVENTION

A method is provided for demosaicing an offset geometric array. The method comprises the step of arranging a plurality of sensors in an offset geometric array. The sensors have a defined geometric shape for each sensor and its respective sensor sample. Another step is moving a first sample from the sensor in an odd row of the offset geometric array to an uppermost point of a geometric shape. A further step is moving a second sample from the sensor in an even row of the offset geometric array to a point that is vertically aligned with the first sample from the odd row. The point is also contained within the same geometric shape as the first sample from the odd row.

### BRIEF DESCRIPTION OF THE DRAWINGS

FIG. 1 is a flowchart illustrating an embodiment of a method for demosaicing an offset geometric array;

FIG. 2 illustrates a schematic of a hexagonal sensor array in accordance with an embodiment of the present invention;

FIG. 3 illustrates groups of RGB values in the hexagonal sensor array of FIG. 1;

FIG. 4 illustrates a demosaiced pixel value for odd rows in a hexagonal sensor array;

FIG. 5 illustrates a demosaiced pixel value for even rows in a hexagonal sensor array; and

FIG. 6 illustrates a flowchart of one embodiment of transforming an offset sensor array.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

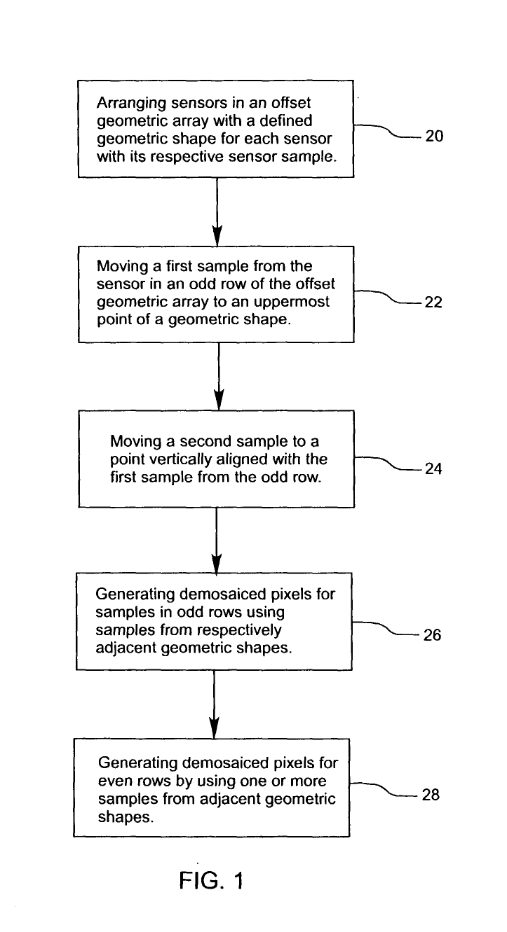

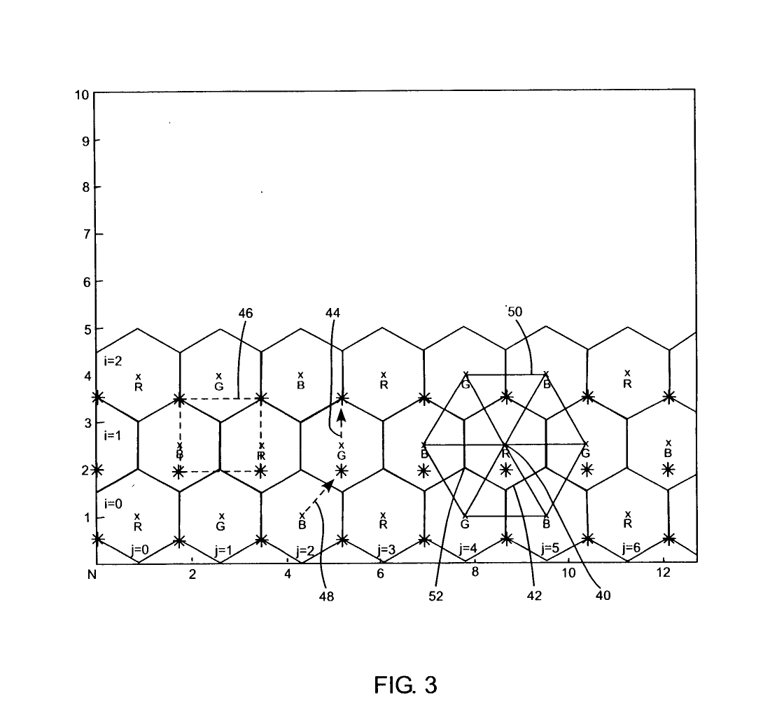

The present invention includes a method for transforming and demosaicing an offset color filter array (CFA) in an imaging system. FIG. 1 is a flowchart illustrating an embodiment of one method for demosaicing an offset geometric array. The method includes the step of arranging a plurality of sensors in an offset geometric array and having a defined geometric shape for each sensor with a respective sensor sample in block 20. The geometric shape can be a circle, triangle, hexagon or similar suitable geometric shape, and the term offset in this description is used to mean that the centers and vertices of the geometric shapes are not aligned vertically or horizontally when the sensor sampling takes place. FIG. 3 illustrates a hexagon arrangement which will be discussed later.

As mentioned, the vertices or center-points of geometric shapes of an offset geometric array do not form a regular rectangular grid but offset samples can provide a denser sampling area. Thus, the RGB values for each geometric shape cannot be used without further processing into a rectangular grid that is needed for many imaging output applications, such as display on a monitor screen.

A further step is moving a first sample from the sensor in an odd row of the offset geometric array to an uppermost point of a geometric shape in block 22. After the samples for the odd row have been moved, the next step is moving a second sample from the sensor in an even row of the offset geometric array to a pre-determined point that is vertically aligned with the first sample from the odd row in block 24. This pre-determined point is within the same geometric shape as the first sample from the odd row. This means that both of the moved or shifted points will be located in the same geometric shape of the geometric array.

After the samples have been set up in a rectangular coordinate system, then demosaicing can take place. Another step is generating demosaiced pixels for a first set of samples in odd rows by selecting sensor samples from respectively adjacent geometric shapes in block 26. A next step is generating demosaiced pixels for a second set of samples in even rows by using one or more sensor samples from adjacent geometric shapes in block 28. Further details for embodiments that select specific samples from adjacent geometric shapes will be discussed later. The demosaiced pixels will be located at the same position as the raw samples that have been moved or shifted. More specifically, the demosaiced pixels for the first set of samples can be moved to an uppermost point of the geometric shapes that each contain the samples in the odd row. The demosaiced pixels for the second set of samples can be moved to points that are aligned in a vertical direction with the first set of samples from the odd row. In addition, the second set of samples in the even row can be horizontally aligned with the uppermost point of two adjacent geometric shapes that adjoin at least one bottom edge of the geometric shape within the odd row (see FIG. 3).

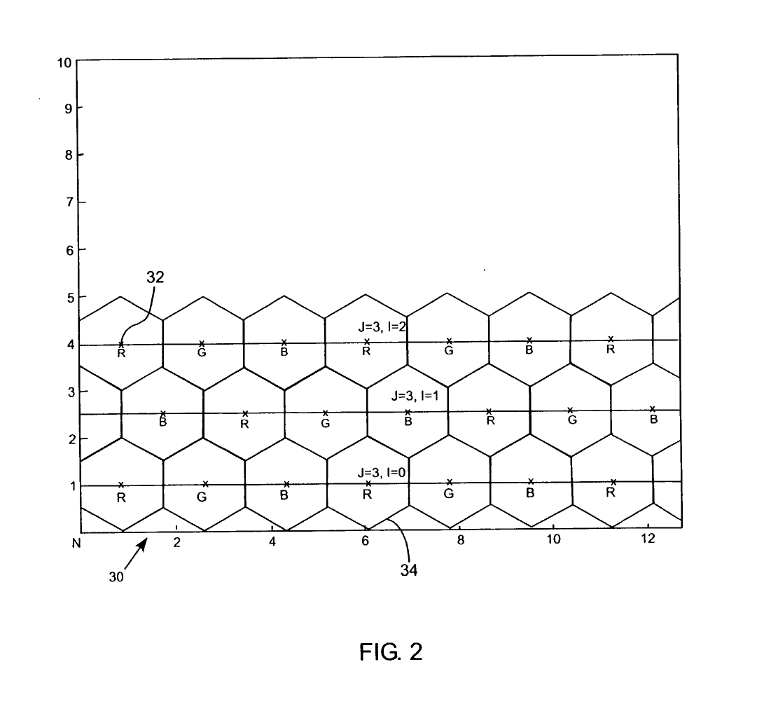

One embodiment of the invention can be used in a camera or imaging system that has a hexagonally placed sensor array. FIG. 2 illustrates a hexagonal grid that has a mosaic pattern 30 with a sensor located in the center of each hexagon as depicted by an X. This figure illustrates a representative section from the hexagonal grid with a relative origin that is not necessarily the absolute origin of the grid. Each hexagon in the grid is given an (I, J) location. For example, a hexagon 34 can have a row coordinate of I=0 (an even row) and a column coordinate of J=3.

Prior sensor sampling and demosaicing systems have been based on rectangular arrays, which are known to have a lower sampling density then a hexagonal grid for the same space by a factor of \sqrt{3}/2. A lower sampling-density implies worse image quality and demosaicing artifacts for the same image and demosaicing method. At current imaging resolutions approaching the mega-pixel range and higher, rectangular arrays require a substantial amount of computing power and fairly complex demosaicing schemes for acceptable image quality. On the other hand, the present invention discloses a demosaicing scheme for an offset polygon grid or hexagonal grid, which involves a reduced amount of processing of the raw data. The higher sampling rate of a hexagonal grid in a given space also aids in providing an enhanced image quality, which is not available with simple demosaicing schemes for rectangular sampled arrays.

As shown in FIG. 3, adjoining RGB pixels or samples form triangles 50. A given pixel 40 is surrounded by three pixels in each of the other two colors (six pixels in all) and hence the given pixel forms the base vertex 40 of each of six adjoining triangles. The centers of these triangles form the vertices of the original hexagon 52.

The RGB values on the vertices of a given triangle may be used to approximate the RGB values of a pixel centered on the triangle's center (or centroid), and hence on a vertex of the original hexagon. Unfortunately, the vertices of the hexagonal array do not form a regular rectangular grid. Accordingly, the RGB values for each triangle cannot be used in a regular rectangular grid without further processing, but the RGB values for some triangles can be used. The regular rectangular grid is needed for displaying the image on a computer screen, printing, and other output that is displayed in rectangular grid fashion.

In an embodiment of the present invention, the data from the sensors is provided in the following form:

RGBRGBRGBRGB
BRGBRGBRGBRG

Other color sensor arrangements can be used, such as CMY or similar well known color arrangements. Assuming that r (I, J) represents the (row, column) format of the raw data, and the hexagonal grid numbering starts at (0,0), the coordinates are:

R: (0, 0)

G: (0, 1)

B: (0, 2)

R: (0, 3)

G: (0, 4)

and so on in row zero. For the next row,

B: (1, 0)

R: (1, 1)

G: (1, 2)

B: (1, 3)

R: (1, 4)

In this embodiment, the even numbered rows start with a red pixel, and odd-numbered rows with a blue pixel. This could also be reversed or other color mosaic schemes could be implemented by one skilled in the art.

Further, let K take on the values 0,1,2 respectively for frames R,G,B and let f(K,I,J) represent the K^{th} frame value at the pixel (I, J) in the demosaiced image. As discussed previously, a frame represents the set of all raw pixels and demosaiced pixels belonging to one color. For example, an RGB system will generally use one red frame, one green frame, and one blue frame.

Accordingly, an embodiment of the present invention uses a specific selection of raw pixels and modified pixels from the hexagonal grid to generate demosaiced pixels. The coordinate system for the demosaiced image is as follows.

When I is odd, the (I, J) pixel is moved to the topmost vertex of the hexagonal pixel (I, J). This is illustrated by the arrow 44 in FIG. 3 that represents the movement of the raw data to the specified point. This moved point will be calculated in X and Y rectangular coordinates after it is moved.

When I is even, the (I, J) demosaiced pixel is directly below the (I+1, J) demosaiced pixel and exactly in between the topmost vertices of hexagonal pixels centered at (I, J) and (I, J+1). This is illustrated by the arrow 48 in FIG. 3 that represents the movement of the raw data in the even row to the specified asterisk in FIG. 3. This location is used for the even pixel because it allows the pixel to be half way between the pixel above it at (I+1, J) and the pixel below it at (I−1, J) in order to form a rectangular grid. That puts the even pixel's position exactly between those two topmost vertices. Notice that the modified coordinates, the asterisks, form a rectangular grid as illustrated by the square dotted line 46. This is in contrast to the hexagon centers which form a grid with offset center points. An alternative embodiment of the present invention can switch the arrangement that is applied to the odd and even rows, which would still result in a rectangular grid.

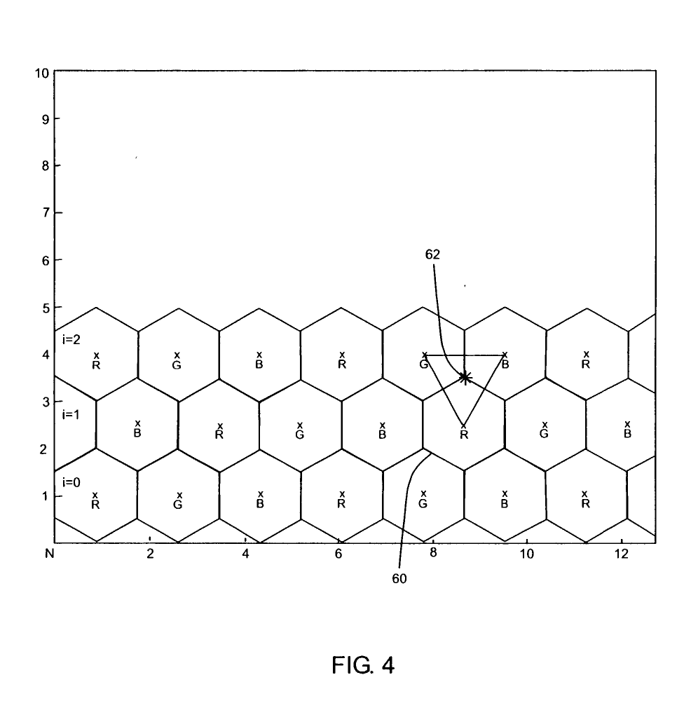

The following expressions are used to select the demosaiced values. When I is odd, FIG. 4 illustrates that the column number J of the raw pixel data corresponds to a measurement of frame K=(J+2) mod3 where the red frame=0, the green frame=1, the blue frame=2. For the triangle with a vertex at the centre of hexagon (I, J) and one side horizontal, whose center is the demosaiced pixel (I, J), the values of each frame are derived from the values at the triangle vertices. The raw value at these pixel locations can be used as a demosaiced value or the demosaiced value can be interpolated or approximated from the identified raw value:

f(Jmod3, I, J)=r(I+1, J) Equation 1

f((J+1)mod3, I, J)=r(I +1, J+1) Equation 2

f((J+2)mod3, I, J)=r(I, J) Equation 3

For example, if the hexagonal coordinate 60 is (I=1, J=4), then the hexagon will contain a red sensor which will be the pixel for the red frame in this example embodiment. The equations listed above further identify which hexagon samples will be selected for demosaicing purposes. Since the frame numbers (R=0, G=1, B=2) are being used, the equation Jmod3 will identify the correct color frame for the specific hexagon in question. In equation 3, when (J+2)mod3 is evaluated where J=4, this returns a result of 0 which corresponds to red. So, for the red frame the r(I, J) hexagon value is selected or (1,4). This is correct based on the example arrangement of the hexagonal grid in FIG. 4.

In equation 2, when J=4 is used to evaluate (J+1)mod3, this returns the value of 2 which corresponds to the blue frame and the value r(I+1, J+1) is a blue value that can either be used directly or interpolated to create the demosaiced value. In equation 1, when the value of J=4 is evaluated in Jmod3, this returns a value of 1 which represents the green frame. So, the hexagon r(I+1, J) will be selected which is a green sensor and this raw value can be used or interpolated. As the J value of the hexagon that is being demosaiced changes, these equations select the correct values for the appropriate frame. These odd demosaiced values will also be moved or interpolated to the modified pixel location 62.

The demosaicing scheme described for the odd pixels helps minimize processing while maintaining the accuracy. Values that are adjacent to the center of the demosaiced pixel 62 are used because the values closer to the centroid of a triangle are the more accurate values. This odd pixel uses only one raw value per pixel per frame because any other RGB values that might be averaged into the final pixel would be too far from the centroid as compared to the adjacent pixels.

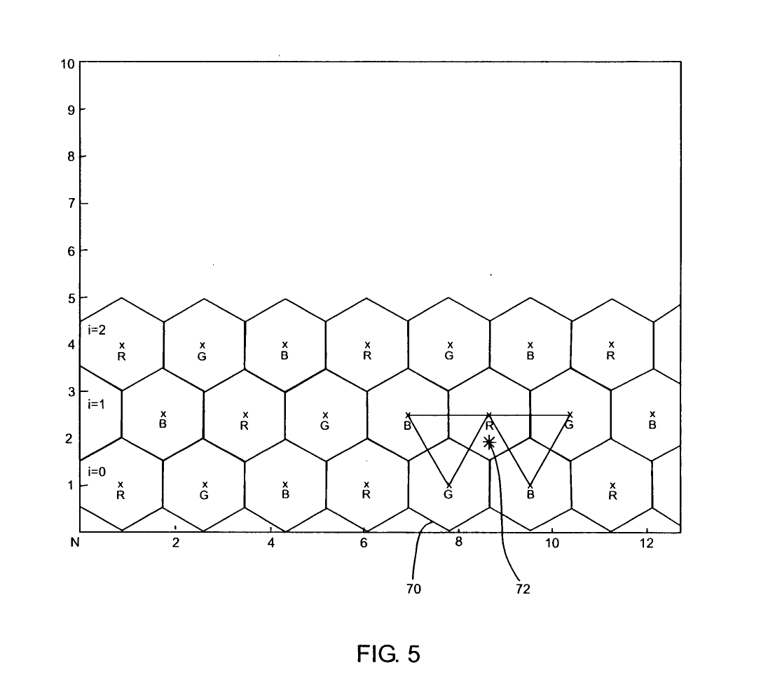

When I is even, the pixel's column number J for the raw data corresponds to a measurement of frame K=Jmod3, as illustrated in FIG. 5. Recall that when I is even, the shifted pixel (I, J) or pixel with rectangular coordinates is at the mid-point for the topmost vertices of hexagons (I, J) and (I, J+1). This way two of the demosaiced values are approximated as an average of the two values at the vertices of the hexagons at (I, J) and (I, J+1):

$$\begin{matrix}f ( J mod 3 , I , J ) = \frac{r ( I , J ) + r ( I + 1 , J + 1 )}{2} & Equation 4 \\ f ( ( J + 1 ) mod 3 , I , J ) = \frac{r ( I , J + 1 ) + r ( I + 1 , J - 1 )}{2} & Equation 5\end{matrix}$$

f((J+2)mod3, I, J)=r(I+1, J) Equation 6

These equations for demosaicing the even hexagonal samples work in a similar way as the odd equations. For example, as illustrated in FIG. 5, a sample hexagon 70 in an even row at (I=0, J=4) can be used. In equation 6, when J=4 is used in (J+2)mod3, it evaluates to 0 or the red frame, and thus the value of r(I+1, J) is used which is a red hexagon at (1,4). In equation 5, J=4 in (J+1)mod3 evaluates to 2 or the blue frame. Then the two blue hexagons r(I, J+1) at (0,5) and r(I+1, J−1) at (1,3) are averaged to provide a demosaiced value for the blue frame. In equation 4, J=4 used in Jmod3 evaluates to 1 which is the green frame and the green hexagons r(I, J) at (0,4) and r(I+1, J+1) at (1,5) are used in calculating the demosaiced point.

It is notable that two of the demosaiced pixels use an average of two other pixels and one is demosaiced from one pixel. This is because the rectangular sample point sits in the middle of center points of the two triangles as illustrated in FIG. 5. So, the pixel's demosaiced values are the average of the pixels values at each triangle centroid. In this invention, the RGB pixel values of a triangle centroid are essentially the RGB values on the triangle vertices. This is true for the odd rows as well. So, the demosaiced pixel values at an even rectangular sample point, which is located in the center of the two triangles, is the average of the pixel values on the vertices of the two triangles. The two triangles also share a common point and this point is close to the demosaiced pixel or center of the two triangles, so this pixel is used without any averaging.

The method of the present invention provides a number of valuable functions. In contrast to conventional digital imaging systems, the present system and method uses data captured from a hexagonal grid of sensors which is denser that a rectangular sampling grid in two dimensions. Unlike a conventional rectangular sensor grid, digital imaging using a hexagonal grid has a more equal distribution of colors in all directions.

Since the present imaging system uses a computationally efficient demosaicing scheme which is tailored for the hexagonal grid, processing speeds for this method can generally be faster than the prior demosaicing schemes. The simplicity of the demosaicing scheme also provides room in the physical hardware to include JPEG compression on the same chip. This is significant because JPEG compression usually reduces the compressed data size to less than one-third of the original image size. Hence it is valuable to compress the image in the camera or imaging device. One option with any sensor that captures raw data in a mosaic pattern is to always perform demosaicing off the camera or imaging device, and send the raw data as is to a computer. Unfortunately, raw undemosaiced data cannot generally be JPEG compressed. Hence, the amount of data output by the sensor array is equal to the number of sensors. In contrast, when the image is demosaiced on camera as in the present invention, then the image can be JPEG compressed and output to a computer. This allows the present invention to increase the data (through demosaicing) to three times the number of sensors, but then reduce the data output to considerably less by using compression (e.g. JPEG). An advantage of the present method over other demosaicing methods is the demosaicing scheme has minimal processing and this allows for the recovery of the original raw data values on the host computer if more sophisticated demosaicing schemes are needed after the image has been retrieved from the imaging device.

The demosaicing scheme of the present invention does not change the value of the raw data significantly. The present method averages two values at most. In addition, getting the original raw data values back from the demosaiced, compressed data is much easier. This result is possible for the averaged points because the raw data used in averaging is also used to form the vertices of other triangles for odd rows. Thus, this data is preserved in the odd rows and can be accessed, if necessary. The total data in the demosaiced image is three times the number of sensors that sample raw data. So, the values that are sent as averages can be thrown away or used as additional constraints when performing additional demosaicing or processing.

Prior demosaicing solutions involve JPEG compression of demosaiced and tremendously altered raw data. Hence, the raw sampling data is not easily recovered from the compressed data and the host computer cannot substantially process raw data for extremely high image quality. The present method allows the imaging device to compress mostly unprocessed raw data or demosaiced data. This less processed data can then be processed extensively on the host or final destination device for higher image quality, if necessary, using any number of post-processing algorithm known to those skilled in the art.

Prior solutions that involve compressing gray-scale raw data do not result in good compression ratios as compared to the present method. In grey scale mosaiced data, consecutive values in the one frame are not similar because they are from different colors. When compressing demosaiced data in the present invention, consecutive points in a single frame are more similar because they are either approximated or directly measured for the same color.

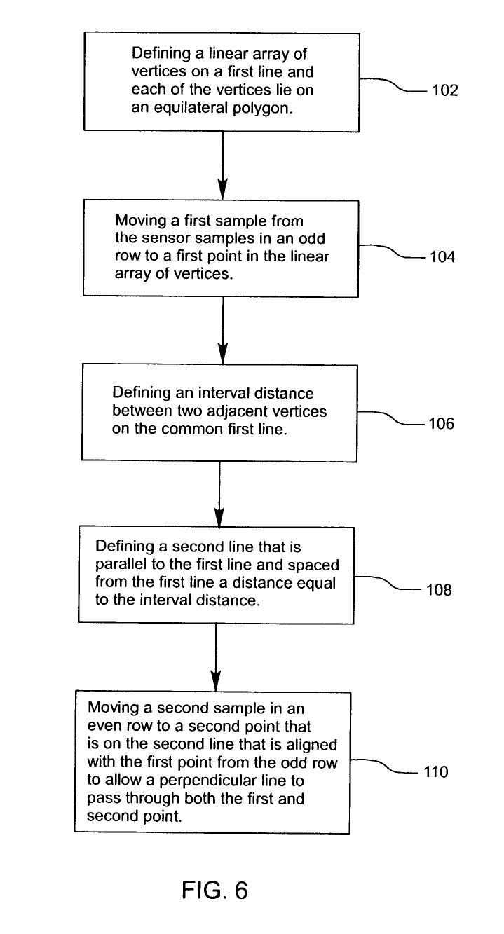

Another illustrative example of the method of present invention will now be described in relation to FIG. 6. This embodiment includes a method for converting an offset geometric array of equilateral polygons containing sensor samples to a rectangular array of samples. The method includes the step of defining a linear array of vertices on a first line within the offset geometric array and each of the vertices lie on an equilateral polygon in the offset geometric array in block 102. An additional step is moving a first sample from sensor samples in an odd row of the offset geometric array to a first point in the linear array of vertices in block 104. Another step is defining an interval distance between adjacent vertices on the first line in block 106. A further step is defining a second line that is arranged parallel to the first line and spaced from the first line a distance equal to the interval distance in block 108. Yet another step is moving a second sample from sensor samples in an even row to a second point on the second line that is aligned with the first point from the odd row to allow a perpendicular line to pass through both the first and second point in block 110.

This arrangement aligns a first set of samples from the odd row with a second set of samples from the even row to form a rectangular grid. Essentially, these steps described can be repeated for as many points exist within the grid. After the rectangular grid has been created the demosaiced pixels can be generated for the first set of samples in odd rows by selecting sensor samples from adjacent geometric shapes. Additional demosaiced pixels can be generated for even rows by combining at least two sensor samples from adjacent geometric shapes. The equilateral polygon in the grid can be triangles and hexagons or similar polygons.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

What is claimed is:

1. A method for transforming an offset geometric array to a rectangular array, comprising the steps of:
arranging a plurality of sensors in an offset geometric array, having a defined geometric shape for each sensor with a respective sensor sample;
moving a first sample from the sensor in an odd row of the offset geometric array to an uppermost point of a geometric shape; and
moving a second sample from the sensor in an even row of the offset geometric array to a point that is vertically aligned with the first sample from the odd row, and the point is within the same geometric shape as the first sample from the odd row.

2. A method as in claim 1, further comprising the step of:
generating demosaiced pixels for each sample in odd rows by selecting sensor samples from respectively adjacent geometric shapes;
generating demosaiced pixels for each sample in even rows by combining at least two sensor samples from adjacent geometric shapes.

3. A method as in claim 2, further comprising the step of moving pixels for each sample in an odd row to an uppermost point of the geometric shape that contains the sample in the odd row.

4. A method as in claim 2, further comprising the step of moving pixels for each sample in even rows to the point that is aligned in a vertical direction with the each sample from the odd row.

5. A method as in claim 1, further comprising the step of:
generating demosaiced pixels for each samples in odd rows by selecting sensor samples from an adjacent geometric shape;
generating demosaiced pixels for even rows by using one or more samples from adjacent geometric shapes.

6. A method as in claim 1, further comprising the step of aligning the even sample horizontally with the uppermost point of two adjacent geometric shapes that adjoin at least one bottom edge of the geometric shape within the odd row.

7. A method for demosaicing a hexagonal array, comprising the steps of:
arranging a plurality of sensors in the hexagonal array with a defined hexagon for each sensor and a respective sensor sample;
moving a first set of samples from the sensors in an odd row to an uppermost vertex of a respective hexagon boundary of a hexagon in the odd row; and
moving a second set of samples from the sensors in an even row to points that are aligned in a vertical direction with the first set of samples from the odd row and are within the same hexagon boundary as the first set of samples from the odd row;
generating demosaiced pixels for the first set of samples in the odd row by selecting samples from adjacent hexagons;
generating demosaiced pixels for the second set samples in even rows by using one or more samples from adjacent hexagons.

8. A method as in claim 7, further comprising the step of aligning horizontally the second set of samples from the even row with uppermost vertices of two adjacent hexagons from the even row that adjoin two bottom sides of the hexagon in the odd row.

9. A method as in claim 8, further comprising the step of forming a rectangular grid with the sensor samples from even rows and odd rows.

10. A method as in claim 7, wherein the step of generating demosaiced pixels further comprises the step of generating a red demosaiced pixel using adjacent sampled red pixels.

11. A method as in claim 7, wherein the step of generating demosaiced pixels further comprises the step of generating a blue demosaiced pixel using adjacent sampled blue pixels.

12. A method as in claim 7, wherein the step of generating demosaiced pixels further comprises the step of generating a green demosaiced pixel using adjacent sampled green pixels.

13. A method for demosaicing a hexagonal sampling array to a rectangular coordinate array, comprising the steps of:
arranging a plurality of sensors in the hexagonal sampling array with a hexagon for each sensor and an (I, J) location, where I represents a row and J represents a column;
moving a first set of samples from the sensors in an odd row to an uppermost vertex in a corresponding (I, J) hexagon within which the sensor is contained; and
moving a second set of samples from the sensors in an even row to points that are aligned in a vertical direction with the first set of samples from the odd row and that are within the same (I, J) hexagon as a sample from the odd row;
generating demosaiced pixels for an odd row by selecting a sensor sample from an adjacent hexagon bordering the (I, J) hexagon;
generating demosaiced pixels for even rows by using at least one sensor sample from adjacent hexagons.

14. A method as in claim 13, wherein the step of generating a demosaiced pixel further comprises the step of generating a first demosaiced pixel for a pixel associated with the odd row.

15. A method as in claim 14 further comprising the step of generating the demosaiced pixel using a sample at coordinate r(I+1, J) when the equation Jmod3 evaluates to a number which identifies the output frame for the coordinate r(I+1, J) as either (R=0, G=1, B=2).

16. A method as in claim 14 further comprising the step of generating the demosaiced pixel using a sample at coordinate r(I+1, J+1) when the equation (J+1)mod3 evaluates to zero which identifies the output frame for the coordinate r(I+1, J+1) as either (R=0, G=1, B=2).

17. A method as in claim 14 further comprising the step of generating the demosaiced pixel using a sample at coordinate r(I, J) when the equation (J+2)mod3 evaluates to zero which identifies the output frame for the coordinate r(I, J) as either (R=0, G=1, B=2).

18. A method as in claim 13, further comprising the step of generating demosaiced pixels for even rows by combining two samples from adjacent hexagons.

19. A method as in claim 13, wherein the step of generating a demosaiced pixel further comprises the step of generating a first demosaiced pixel for a pixel associated with the even row.

20. A method as in claim 19, further comprising the step of identifying a demosaiced pixel using a sample at coordinate r(I+1,J) when the equation (J+2)mod3 evaluates to a number which identifies the output frame for the coordinate r(I+1,J) as either (R=0, G1, B=2).

21. A method as in claim 19, wherein the step of generating a demosaiced pixel further comprises the step of generating a demosaiced pixel for an even pixel using samples at coordinates
$$\frac{r ( I , J + 1 ) + r ( I + 1 , J - 1 )}{2}$$
when the equation (J+1)mod3 evaluates to a number which identifies the output frame for the coordinate
$$\frac{r ( I , J + 1 ) + r ( I + 1 , J - 1 )}{2}$$
as either (R=0, G=1, B=2).

22. A method as in claim 13, wherein the step of generating a demosaiced pixel further comprises the step of generating a demosaiced pixel for an even pixel using samples at coordinates
$$\frac{r ( I , J ) + r ( I + 1 , J + 1 )}{2}$$
when the equation Jmod3 evaluates to a number which identifies the output frame for the coordinate
$$\frac{r ( I , J ) + r ( I + 1 , J + 1 )}{2}$$
as either (R=0, G=1, B=2).

23. An article of manufacture, comprising:
a computer usable medium having computer readable program code means embodied therein for demosaicing an offset geometric array, the computer readable program code means in the article of manufacture comprising:
computer readable program code means for arranging a plurality of sensors in an offset geometric array, having a defined geometric shape for each sensor with a respective sensor sample;
computer readable program code means moving a first sample from the sensor in an odd row of the offset geometric array to an uppermost point of a geometric shape; and
computer readable program code means moving a second sample from the sensor in an even row of the offset geometric array to a point that is vertically aligned with the first sample from the odd row, and the point is within the same geometric shape as the first sample from the odd row.

24. A method for converting an offset geometric array of equilateral polygons containing sensor samples to a rectangular array of samples, comprising the steps of:
defining a linear array of vertices on a first line within the offset geometric array and each of the vertices lie on an equilateral polygon in the offset geometric array;
moving a first sample from sensor samples in an odd row of the offset geometric array to a first point in the linear array of vertices;
defining an interval distance between adjacent vertices on the first line;
defining a second line that is arranged parallel to the first line and spaced from the first line a distance equal to the interval distance;
moving a second sample from sensor samples in an even row to a second point on the second line that is aligned with the first point from the odd row to allow a perpendicular line to pass through both the first and second point.

25. A method as in claim 24 further comprising the step of aligning a first set of samples from the odd row with a second set of samples from the even row to form a rectangular grid.

26. A method as in claim 25, further comprising the steps of:
generating demosaiced pixels for the first set of samples in odd rows by selecting sensor samples from adjacent geometric shapes;
generating demosaiced pixels for even rows by combining at least two sensor samples from adjacent geometric shapes.

27. A method as in claim 21, further comprising the step of providing an equilateral polygon that is selected from the group of equilateral polygons consisting of triangles and hexagons.

28. A method as in claim 21, further comprising the step of defining the linear array of vertices on the first line as being located on a vertex of the equilateral polygon.
